(19) United States
(12) Patent Application Publication
(10) Pub. No.: US 2026/0296217 A1
(43) Pub. Date: Oct. 1, 2026

(54) AXLE DISCONNECT WITH RESERVE POWER

(71) Applicant: FCA US LLC, Auburn Hills, MI (US)

(72) Inventors: Krishna Chaitanya Reddy Madireddy, Auburn Hills, MI (US); Nadirsh D. Patel, Auburn Hills, MI (US); Brandon M. Verhun, Auburn Hills, MI (US)

(21) Appl. No.: 19/095,256

(22) Filed: Mar. 31, 2025

(51) Int. Cl. B60L 15/20

(52) U.S. Cl. CPC B60L 15/2054; B60L 15/2045; B60L 2240/12; B60L 2240/421; B60L 2240/423; B60L 2240/507; B60L 2240/54

(57) ABSTRACT

A vehicle includes a powertrain having first and second electric traction motors, a high voltage (HV) battery system, and an axle disconnect system. A control system includes a controller programmed to command the axle disconnect system to disconnect a first axle from the first electric traction motor, reserve, from the HV battery system, a predetermined amount of power required to spin up the disconnected first electric traction motor to a target speed that enables re-engagement of the first electric traction motor and the first axle, and power, by the HV battery system, the second electric traction motor to meet a driver torque demand. Upon receiving a command to reconnect the axle disconnect system, the control system utilizes the reserve power to spin up the disconnected first electric traction motor to the target speed and re-engage the first electric traction motor and the first axle.

### FIELD

The present application relates generally to vehicle axle disconnect systems and, more particularly, to vehicle axle disconnect systems with dynamic reserve power allocation.

### BACKGROUND

Vehicle axle disconnect systems typically include front axle disconnect (FAD) and/or wheel-end disconnect (WED) systems that are capable of selectively disconnecting a powertrain (an electric motor, an engine, or some combination thereof) from the vehicle wheels. In some electric vehicles, re-engaging a disconnected axle requires allocating power to spin up the motor on that axle. Without a designated reserve, diverting power from the connected axle to the disconnected axle can lead to an abrupt reduction in acceleration that affects drivability. Known systems generally allocate power for axle engagement only when needed. These systems often calculate a static reserve power amount, failing to account for changing vehicle speeds or time-to-close adjustments. This reactive approach can result in noticeable power shifts, as the connected axle's power is abruptly reduced, thereby impacting drivability. Such a static reserve approach lacks the adaptability to adjust for real-time vehicle speed or variable time-to-close requirements, potentially making the power distribution less efficient and leading to delayed clutch engagement. Accordingly, while such systems work well for their intended purpose, there remains a desire for improvement in the relevant art.

### SUMMARY

In accordance with one example aspect of the invention, a vehicle is provided. In one example, the vehicle includes a powertrain having a first electric traction motor configured to provide torque to a first axle and a second electric traction motor configured to provide torque to a second axle, a high voltage (HV) battery system configured to power the first and second electric traction motors, and an axle disconnect system configured to selectively disconnect the first axle from the first electric traction motor. A control system includes a controller programmed to command the axle disconnect system to disconnect the first axle from the first electric traction motor, reserve, from the HV battery system, a predetermined amount of power required to spin up the disconnected first electric traction motor to a target speed that enables re-engagement of the first electric traction motor and the first axle, and power, by the HV battery system, the second electric traction motor to meet a driver torque demand. Upon receiving a command to reconnect the axle disconnect system, the control system utilizes the reserve power to spin up the disconnected first electric traction motor to the target speed and re-engage the first electric traction motor and the first axle.

In addition to the foregoing, the described vehicle may include one or more of the following features: wherein the predetermined reserve power is continuously held while the first electric traction motor is disconnected from the first axle; wherein the predetermined target speed is a speed that enables re-engagement without perceptible acceleration loss; wherein when the disconnected first electric traction motor reaches the target speed, the controller is further programmed to release at least a portion of the predetermined reserve power to be utilized by the connected second electric traction motor; and wherein the controller is further programmed to gradually reduce the amount of reserve power as the disconnected first electric traction motor reaches the target speed, such that a portion of the reserve power is available to power the second electric traction motor.

In addition to the foregoing, the described vehicle may include one or more of the following features: wherein the gradual reduction of the reserve power is a linear reduction; wherein the predetermined amount of reserve power is determined based on target speed data of the first electric traction motor and time-to-close parameters of the axle disconnect system; wherein the axle disconnect system includes at least one clutch to selectively connect the first electric traction motor and the first axle; wherein the axle disconnect system is a front axle disconnect (FAD) system; and wherein the axle disconnect system is a wheel-end disconnect (WED) system.

In accordance with another example aspect of the invention, a control method for an electrified vehicle having a powertrain with first and second electric traction motors, an axle disconnect system configured to selectively disconnect the first electric traction motor from a first axle, and a high voltage (HV) battery system is provided. In one example, the method includes commanding, by a controller having one or more processors, the axle disconnect system to disconnect the first axle from the first electric traction motor; reserving, from the HV battery system, a predetermined amount of power required to spin up the disconnected first electric traction motor to a target speed that enables re-engagement of the first electric traction motor and the first axle; powering, by the HV battery system, the second electric traction motor to meet a driver torque demand; and upon receiving a command to reconnect the axle disconnect system, utilizing the reserve power to spin up the disconnected first electric traction motor to the target speed and re-engage the first electric traction motor and the first axle.

In addition to the foregoing, the described method may include one or more of the following features: continuously holding the predetermined reserve power while the first electric traction motor is disconnected from the first axle; wherein the predetermined target speed is a speed that enables re-engagement without perceptible acceleration loss; wherein when the disconnected first electric traction motor reaches the target speed, the method further comprises releasing, by the controller, at least a portion of the predetermined reserve power to be utilized by the connected second electric traction motor; and gradually reducing, by the controller, the amount of reserve power as the disconnected first electric traction motor reaches the target speed, such that a portion of the reserve power is available to power the second electric traction motor.

In addition to the foregoing, the described method may include one or more of the following features: wherein the gradual reduction of the reserve power is a linear reduction; wherein the predetermined amount of reserve power is determined based on target speed data of the first electric traction motor and time-to-close parameters of the axle disconnect system; wherein the axle disconnect system includes at least one clutch to selectively connect the first electric traction motor and the first axle; wherein the axle disconnect system is a front axle disconnect (FAD) system; and wherein the axle disconnect system is a wheel-end disconnect (WED) system.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of an example vehicle with an axle disconnect system in accordance with the principles of the present application; and

FIG. 2 is a flow diagram illustrating an example method of operating the vehicle of FIG. 1, in accordance with the principles of the present application.

### DETAILED DESCRIPTION

As previously discussed, some vehicles may include axle disconnect systems configured to selectively disconnect vehicle wheels from a powertrain (e.g., engine and/or electric motor). In electric vehicles, re-engaging a disconnected axle typically required allocating power to sin up the motor on the disconnected axle. Without a designated reserve, diverting power from the connected axle to the disconnected axle may lead to an abrupt reduction in acceleration that affects drivability.

Accordingly, systems and methods are described herein that provide an axle disconnect system configured to maintain a continuous, dynamically depleting power reserve while the axle is disconnected to ensure smooth re-engagement without sudden power adjustments. In one example, the system optimizes axle disconnect engagement in electric vehicles with motors on each axle, to maintain seamless drivability through dynamic reserve power allocation. When one axle is disconnected, a supervisory controller holds a reserve amount of power that is required to spin up the disconnected motor to a target speed, enabling clutch engagement without perceptible acceleration loss. This reserve power remains held while the axle is disconnected and depletes progressively as the disconnected motor approaches target speed, thereby allowing additional power to be accessed by the connected axle motor. This gradual depletion ensures that power becomes available for driver demand as the disconnected motor needs less power to reach its target speed. Calculated offline, the reserve power is based on vehicle speed and a calibratable “time to close” parameter, allowing the system to reserve only the minimum necessary power for smooth, efficient engagement.

As such, the system described herein includes a continuous power reserve held throughout axle disconnection, with the reserve power depleting as the disconnected motor approaches target speed. By gradually releasing the reserved power to the connected axle, the system allows additional power for driver demands while ensuring sufficient power remains for re-engagement. The reserve power amount is calculated offline, using data on target speed and time-to-close parameters. The “time to close” is also calibratable, allowing flexibility to adapt reserve requirements to different driving conditions, minimizing unnecessary power allocation.

Accordingly, system provides a dynamic, diminishing power reserve, which enhances drivability by ensuring a seamless power transition. Unlike static or reactive solutions, this approach utilizes a continuously held, adaptively calculated power reserve that gradually reduces as the disconnected motor nears target speed. The calibratable time-to-close parameter also allows the power reserve to be minimized based on specific driving scenarios, thereby maximizing efficiency. This adaptable and continuous power reserve approach provides an improved driver experience by maintaining smooth vehicle acceleration and ensuring power is always available for axle re-engagement.

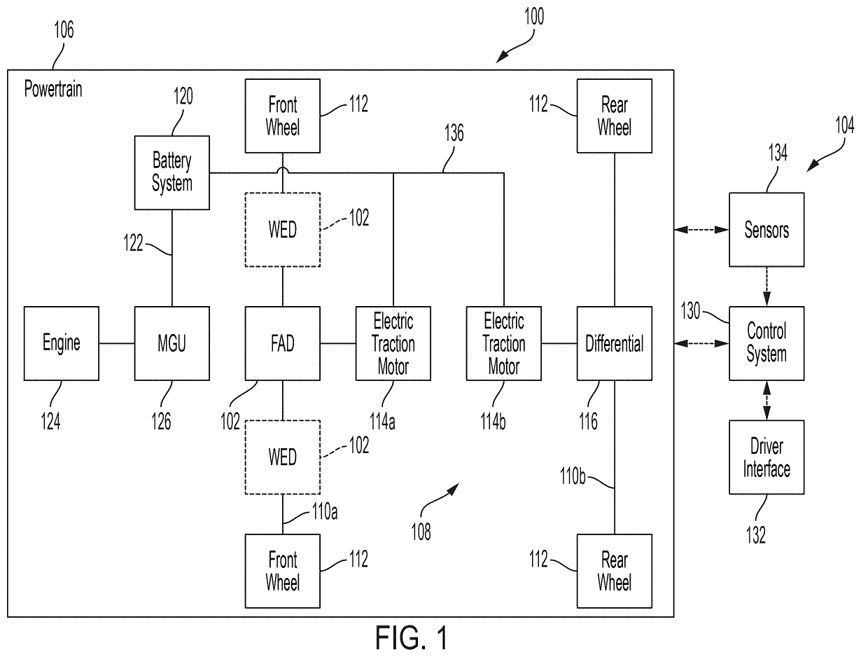

Referring now to FIG. 1, a functional block diagram of an electrified vehicle 100 an axle disconnect system 102 and an axle disconnect control system 104 according to the principles of the present application are illustrated. The vehicle 100 generally includes a powertrain 106 configured to generate and transfer drive torque to a driveline 108, which comprises front and rear half-shafts or axles 110a, 110b connected to wheels 112. In the illustrated example, the powertrain 106 is a series hybrid powertrain with at least two electric traction motors 114a, 114b (collectively, “electric traction motors 114”). However, it will be appreciated that powertrain 106 may have various other configurations (e.g., battery electric vehicle or BEV).

The first electric traction motor 114a (also “front electric traction motor 114a”) is associated with the front axle system 110a, which includes the axle disconnect system 102. Front axle system 110a may also include other non-illustrated components, such as a differential. As shown, the axle disconnect system 102 could be configured as a FAD system (for disconnecting the powertrain 106 from the front axle 110a) or a pair of WED systems (for disconnecting the powertrain 106 from the front wheels 112). The axle disconnect system 102 is configured to selectively connect/disconnect the powertrain 106 by any suitable means such as, for example, one or more clutches (not shown). The second electric traction motor (also “rear electric traction motor 114b”) is associated with the rear axle system 110b, which includes a differential 116 and rear wheels 112. Although not shown, it will be appreciated that rear axle system 110b may additionally or alternatively include an axle disconnect system 102.

The electric traction motors 114 are each powered by electrical energy provided by a high voltage (HV) battery pack or system 120 via a HV bus 122. An internal combustion engine 124 is configured to combust a mixture of air and fuel (gasoline, diesel, etc.) to generate mechanical energy that is converted into electrical energy by a motor-generator unit (MGU) 126. The electrical energy output by the MGU 126 is provided for recharging the high voltage battery system 120 and supporting the HV bus 122.

A control system 130 including one or more electronic control units (ECUs) is configured to control operation of the electrified vehicle 100, which primarily includes controlling the powertrain 106 to generate an amount of drive torque to satisfy a driver torque request provided via a driver interface 132 (e.g., an accelerator pedal). The control system 130 can also receive measurements of various operating parameters of the powertrain 106 (speeds, pressures, temperatures, etc.) from a set of sensors 134. In one example, the control system 130 includes the axle disconnect control system 104 and the axle disconnect system 102. The control system 104 may also include one or more ECUs.

In operation, the control system 130 is configured to control various operational aspects of the vehicle 100, including, but not limited to, controlling the powertrain 106 to generate a sufficient amount of drive torque to satisfy a driver torque request. Depending on a magnitude of the driver torque request and other operational parameters of the vehicle 100 (speed, temperature, battery state of charge (SOC) limits/constraints of the powertrain 106, etc.), the control system 130, 104 may command the axle disconnect system 102 to connect or disconnect the front axle 110a or front wheels 112 from the powertrain 106 (e.g., front electric traction motor 114a).

The control system 130 is also configured to reserve power from the HV battery system 120 when the front or rear axles 110a, 110b are disconnected from the powertrain 106. The control system 130 is configured hold the reserve power throughout the axle disconnection to enable the disconnected electric traction motor 114 to be powered up to a target speed when required.

The reserve power is determined based on target speed data and time-to-close parameters. In one example, the target speed data is the target speed required for the electric traction motor 114 to successfully engage the axle 110 and/or wheels 112 (e.g., via one or more clutches) with minimal disturbance to drivability, based on the particular driving conditions (e.g., drive mode, torque demand, etc.). The time-to-close parameter is the time required to close the clutch or connect the electric traction motor 114 to the axle 110 and/or wheels 112 to transfer torque thereto, based on the particular driving conditions.

In the example embodiment, the reserve power is utilized to limit the power drawn from the battery system 120. This also includes the power generated from the engine 124 and MGU 126, if applicable. If the engine 124 and MGU 126 need to consume power (e.g., an engine start), the reserve power will be reduced accordingly to enable the power consumption.

During operation, once the electric traction motor 114 is brought up to the target speed required for the axle connection, the control system 130 is configured to release a portion of the reserve power to the other electric traction motor 114 (e.g., rear motor 114b) while holding enough reserve power for re-engagement of the disconnected electric traction motor 114 (e.g., front motor 114a). This is due, for example, to the disconnected electric traction motor 114 requiring less energy to maintain the target speed than the energy required to spin up to the target speed. In one example, the reserve power is released/reduced linearly at a constant rate until a minimum reserve power is reached that is necessary to complete the re-engagement.

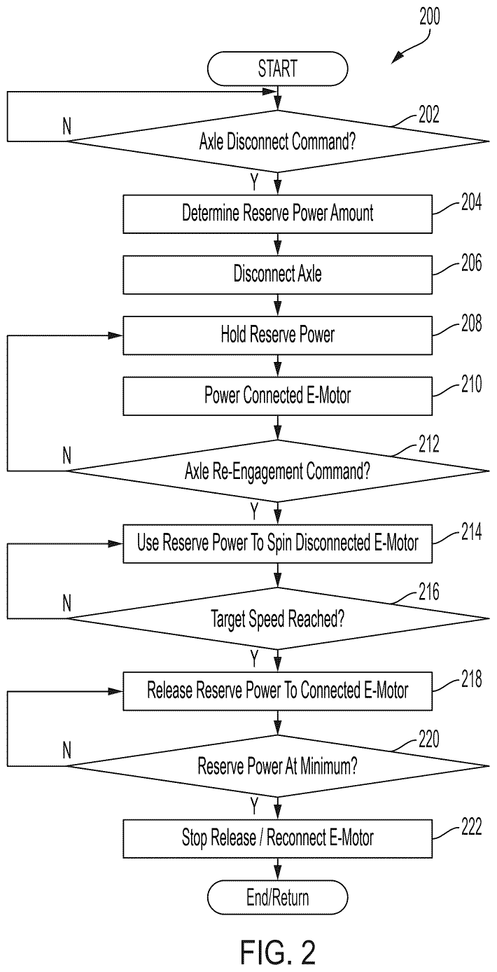

With reference now to FIG. 2, a flow diagram of an example control method 200 of operating the axle disconnect system 102 is illustrated according to the principles of the present disclosure. While the method 200 specifically references the electric vehicle 100 and its components for illustrative/descriptive purposes, it will be appreciated that the method 200 could be applicable to any suitably configured electrified vehicle. The method begins at 202 where controller 104, 130 (“control”) determines if a command is received to disconnect axle 110 from the powertrain 106. If no, control returns to 202. If yes, at 204, control calculates/determines the reserve power amount required to spin up electric motor 114 and re-engage the axle disconnect system 102, for example, based on the current driving conditions. At 206, control disconnects the axle 110 (e.g., axle 110a) from the powertrain 106 (e.g., e-motor 114a).

At 208, control reserves/holds the determined reserve power amount. At 210, control provides power from the HV battery system 120 to the electric motor 114 powering the connected axle 110 (e.g., axle 110b). At 212, control determines if an axle re-engagement command is received. If no, control returns to 208. If yes, control proceeds to 214 and utilizes the reserve power to spin up the disconnected electric motor 114 to the re-engagement target speed.

At 216, control determines if the disconnected electric motor 114 has reached the target speed. If no, control returns to 214. If yes, control proceeds to 218 and releases at least a portion of the reserve power for use by the connected electric motor 114. At 220, control determines if the reserve power has been depleted to the minimum power required for axle re-engagement. If no, control returns to 218. If yes, control proceeds to 222 and either ceases the release of the reserve power or commands the axle disconnect system 102 to reconnect the disconnected electric motor 114 and axle 110. The method then ends or returns to 202.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A vehicle, comprising:
a powertrain including a first electric traction motor configured to provide torque to a first axle and a second electric traction motor configured to provide torque to a second axle;
a high voltage (HV) battery system configured to power the first and second electric traction motors;
an axle disconnect system configured to selectively disconnect the first axle from the first electric traction motor; and
a control system including a controller programmed to:
command the axle disconnect system to disconnect the first axle from the first electric traction motor;
reserve, from the HV battery system, a predetermined amount of power required to spin up the disconnected first electric traction motor to a target speed that enables re-engagement of the first electric traction motor and the first axle;
power, by the HV battery system, the second electric traction motor to meet a driver torque demand; and
upon receiving a command to reconnect the axle disconnect system, utilize the reserve power to spin up the disconnected first electric traction motor to the target speed and re-engage the first electric traction motor and the first axle.

2. The vehicle of claim 1, wherein the predetermined reserve power is continuously held while the first electric traction motor is disconnected from the first axle.

3. The vehicle of claim 1, wherein the predetermined target speed is a speed that enables re-engagement without perceptible acceleration loss.

4. The vehicle of claim 1, wherein when the disconnected first electric traction motor reaches the target speed, the controller is further programmed to:
release at least a portion of the predetermined reserve power to be utilized by the connected second electric traction motor.

5. The vehicle of claim 1, wherein the controller is further programmed to gradually reduce the amount of reserve power as the disconnected first electric traction motor reaches the target speed, such that a portion of the reserve power is available to power the second electric traction motor.

6. The vehicle of claim 5, wherein the gradual reduction of the reserve power is a linear reduction.

7. The vehicle of claim 1, wherein the predetermined amount of reserve power is determined based on target speed data of the first electric traction motor and time-to-close parameters of the axle disconnect system.

8. The vehicle of claim 1, wherein the axle disconnect system includes at least one clutch to selectively connect the first electric traction motor and the first axle.

9. The vehicle of claim 1, wherein the axle disconnect system is a front axle disconnect (FAD) system.

10. The vehicle of claim 1, wherein the axle disconnect system is a wheel-end disconnect (WED) system.

11. A control method for an electrified vehicle having a powertrain with first and second electric traction motors, an axle disconnect system configured to selectively disconnect the first electric traction motor from a first axle, and a high voltage (HV) battery system, the control method comprising:
commanding, by a controller having one or more processors, the axle disconnect system to disconnect the first axle from the first electric traction motor;
reserving, from the HV battery system, a predetermined amount of power required to spin up the disconnected first electric traction motor to a target speed that enables re-engagement of the first electric traction motor and the first axle;
powering, by the HV battery system, the second electric traction motor to meet a driver torque demand; and
upon receiving a command to reconnect the axle disconnect system, utilizing the reserve power to spin up the disconnected first electric traction motor to the target speed and re-engage the first electric traction motor and the first axle.

12. The control method of claim 11, further comprising continuously holding the predetermined reserve power while the first electric traction motor is disconnected from the first axle.

13. The control method of claim 11, wherein the predetermined target speed is a speed that enables re-engagement without perceptible acceleration loss.

14. The control method of claim 11, wherein when the disconnected first electric traction motor reaches the target speed, the method further comprises:
releasing, by the controller, at least a portion of the predetermined reserve power to be utilized by the connected second electric traction motor.

15. The control method of claim 11, further comprising gradually reducing, by the controller, the amount of reserve power as the disconnected first electric traction motor reaches the target speed, such that a portion of the reserve power is available to power the second electric traction motor.

16. The control method of claim 15, wherein the gradual reduction of the reserve power is a linear reduction.

17. The control method of claim 11, wherein the predetermined amount of reserve power is determined based on target speed data of the first electric traction motor and time-to-close parameters of the axle disconnect system.

18. The control method of claim 11, wherein the axle disconnect system includes at least one clutch to selectively connect the first electric traction motor and the first axle.

19. The control method of claim 11, wherein the axle disconnect system is a front axle disconnect (FAD) system.

20. The control method of claim 11, wherein the axle disconnect system is a wheel-end disconnect (WED) system.
